(19) United States
(12) Patent Application Publication
(10) Pub. No.: US 2016/0052560 A1
(43) Pub. Date: Feb. 25, 2016

(54) PROTECTION SYSTEM FOR ATV

(71) Applicant: Mary Peterson, Tooele, UT (US)

(72) Inventor: Mary Peterson, Tooele, UT (US)

(21) Appl. No.: 14/833,908

(22) Filed: Aug. 24, 2015

Related U.S. Application Data
(60) Provisional application No. 62/040,889, filed on Aug. 22, 2014.

(51) Int. Cl. B62D 25/18; B60R 21/13

(52) U.S. Cl. CPC B62D 25/188; B62D 25/182; B60R 21/13

(57) ABSTRACT

An ATV dust guard includes a bar frame to define a protection area connected to an ATV, a dust protection barrier attached to the bar frame, a pivoting mount coupled to the bar frame, and a releasable latch attached to the ATV. The dust protection barrier forms a barrier extending away from the ATV between a seat on the ATV and a rear end of the ATV. The pivoting mount secures the bar frame to a surface of the ATV. The releasable latch prevents the bar frame from pivoting at the pivoting mount.

### CROSS-REFERENCE TO RELATED APPLICATIONS

This application claims the benefit of U.S. Provisional Application No. 62/040,889, filed on Aug. 22, 2014, which is incorporated by reference herein in its entirety.

### BACKGROUND

All-terrain vehicles (ATVs) are generally an open-air style of vehicle. Unlike most automobiles, many ATVs do not have an enclosed passenger space. This allows for unhindered vision for the rider as well as freedom in moving around on the ATV while driving or riding as a passenger. Unfortunately this unenclosed nature of the vehicle also puts the riders at the mercy of the sun, wind, rain, mud, sand, dust, and other environmental conditions as well as in danger in the case of a rollover incident.

### SUMMARY

Embodiments of an ATV dust guard are described. In one embodiment, the ATV dust guard includes a bar frame to define a protection area connected to an ATV, a dust protection barrier attached to the bar frame, a pivoting mount coupled to the bar frame, and a releasable latch attached to the ATV. The dust protection barrier forms a barrier extending away from the ATV between a seat on the ATV and a rear end of the ATV. The pivoting mount secures the bar frame to a surface of the ATV. The releasable latch prevents the bar frame from pivoting at the pivoting mount. Other embodiments of an ATV dust guard are described.

Embodiments of an ATV dust guard apparatus are described. In one embodiment, the ATV dust guard apparatus includes a bar frame, the bar frame including a base frame and a protection frame, the base frame connected to an ATV. The ATV dust guard apparatus further includes a pivoting mount coupled to the base frame, the pivoting mount securing the base frame to the ATV. The ATV dust guard apparatus further includes a releasable latch attached to the ATV. The releasable latch latches to the base frame, preventing the base frame from pivoting at the pivoting mount. The ATV dust guard apparatus further includes a dust protection barrier attached to the protection frame, the dust protection barrier forming a barrier extending away from the ATV. Other embodiments of an ATV dust guard apparatus are described.

Embodiments of an ATV protection system are described. In one embodiment, the ATV protection system includes a bar frame to define a protection area, a dust protection guard applied to the bar frame, the dust protection guard forming a barrier to substantially prevent dust from passing through the protection area. The ATV protection system further includes a pivoting mount coupled to the bar frame, the pivoting mount configured to secure the bar frame to a surface of an ATV and allow the bar frame to pivot at the pivoting mount. The ATV protection system further includes a releasable latch configured to prevent the bar frame from pivoting at the pivoting mount when secured and to allow the bar frame to pivot at the pivoting mount when released. Other embodiments of an ATV protection system are described.

### BRIEF DESCRIPTION OF THE DRAWINGS

FIG. 1 depicts an exploded view of one embodiment of an ATV protection system or dust guard.

FIG. 2 depicts an exploded view of another embodiment of a protection system with a dust protection guard and size adjustment structures.

FIG. 3 depicts one embodiment of a protection system as applied to an ATV.

FIG. 4 depicts another embodiment of a protection system as applied to an ATV.

FIG. 5 depicts a close up view of one embodiment of a protection system as applied to a portion of an ATV.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments provide a protection system or dust guard for an ATV. In general, the protection system or dust guard provides protection from aspects of the environment in which an ATV is operated. For example, the protection system dust guard can reduce the amount of dust to which a rider is exposed on the ATV by creating a protection area between the rider and the rear end or back portion of the ATV. As the ATV rides through dusty, dirty, or muddy conditions, an ATV rider may have dusty, dirt, mud, or other elements kick up from the rear tires. This also occurs because the rear wheels of ATVs are sometimes set at the rear of the ATV without much overhang on the ATV.

Embodiments of the protection system or dust guard may also provide rollover protection for the rider in the case of a rollover of the ATV. In some embodiments, the bar frame or protection frame of the protection system or dust guard extends vertically above where the head of a rider would be as well as horizontally to the sides of where the head of a rider would be located. The bar frame or protection frame could prevent or limit the impact of the ATV on the rider in the event of a rollover accident.

In some embodiments, the protection system or dust guard mounts to an ATV with a pivoting mount and a releasable structure. Some embodiments mount to a rail, rack, or other features, components, or surfaces of an ATV. The pivoting mounts allow the protection system to pivot so that the frame may be pivoted to move forward into a storage or travel position. When secured with the releasable structures, the protection system remains fixed and in place. This allows the protection system to be unobtrusive during times when it is not needed and protective and secure when in use. Additionally, the bar frame may include removal points to facilitate removing portions of the bar frame during storage. For example, the bar frame may include one or more separation points to allow the protection portion of the bar frame to be separated from a base of the bar frame. In this way the bar frame may be converted to a storage or low-profile condition without having to remove the entire system from the ATV. This can allow for quick conversion for removal and/or installation. References herein to the frame or a frame may refer to the bar frame, base frame, or protection frame, or to them collectively, or in any combination.

In some embodiments, the releasable latches on the protection system or dust guard allow for easy installation and transition from securing the bar frame in an upright position for use to removing the protection frame and pivoting the base frame of the bar frame to lay down for storage or transport. The protection system or dust guard may also include one or more support structures to give structural support to the protection system or dust guard. The protection frame may have a flexible or rigid material attached to the protection frame to form a barrier behind a rider. This would prevent at least a portion of the dust or other environmental conditions from affecting the rider. For example, as the ATV is driven down a trail, the dust kicked up by the ATV would normally accumulate on the rider and the ATV. Additionally, the environment may include mud, wind, rain, exhaust, sun, etc. Embodiments of the protection system, when installed on the ATV, protect the rider from at least a portion of the environmental conditions.

The bar frame or dust protection guard may also include mounting points for accessories. For example, the dust protection guard may be a material that includes pockets, sleeves, or other storage functionality. The dust protection guard may also include a storage system to store the protection system for storage of the system on or off of the ATV. The bar frame may include mounting points or hardware for mounting other accessories.

The bar frame may also include size adjustment structures to accommodate installation of the protection system on a range of ATV sizes and dimensions. This may be a pinned, clipped, threaded, spring-button clipped, clamped or secured with some other adjustable connection. The adjustability allows for flexibility in attaching the protection system to a rack, surface, or other structure of the ATV. The size adjustment structures may be located on cross bars of the bar frame to allow for adjusting the width of the bar frame. The size adjustment structures may also or alternatively be located on vertical bars to allow for adjusting the height of the bar frame.

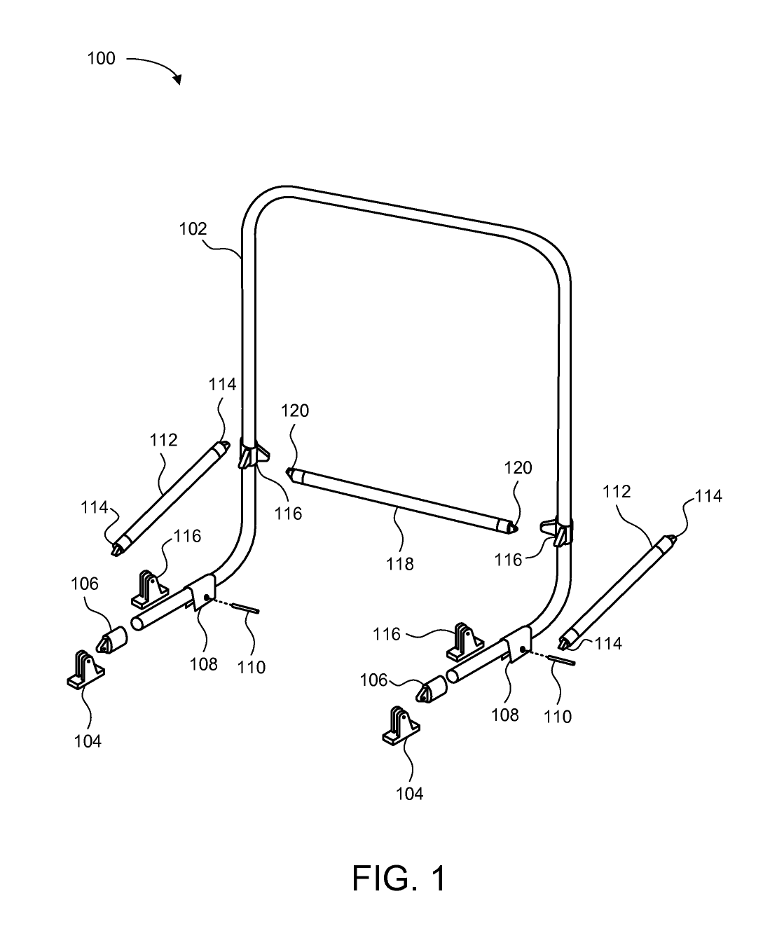

FIG. 1 depicts an exploded view of one embodiment of an ATV protection system or dust guard 100. The system 100 includes a bar frame 102, pivoting mounts 104, pivoting connectors 106, releasable latches 108, removable pins 110, side supports 112 with side support connectors 114, support mounts 116, and an adjustable cross bar 118 with rear support connectors 120.

In the illustrated embodiment, the bar frame 102 is a structure that is bent to have an upright portion and horizontal portions. In some embodiments, the upright portion may be a protection frame and be detachable from the horizontal portion which may be a base frame. In some embodiments, the bar frame 102 may have a tubular or other non-circular cross-section. In some embodiments, the bar frame 102 is solid. In some embodiments, the bar frame 102 is hollow. In some embodiments, the bar frame 102 may have a geometry that varies along the bar frame 102. The bar frame 102 may be constructed of metal, plastic, composite, or some other material. In some embodiments, the bar frame 102 is rigid. In some embodiments, the bar frame 102 has a degree of flexibility.

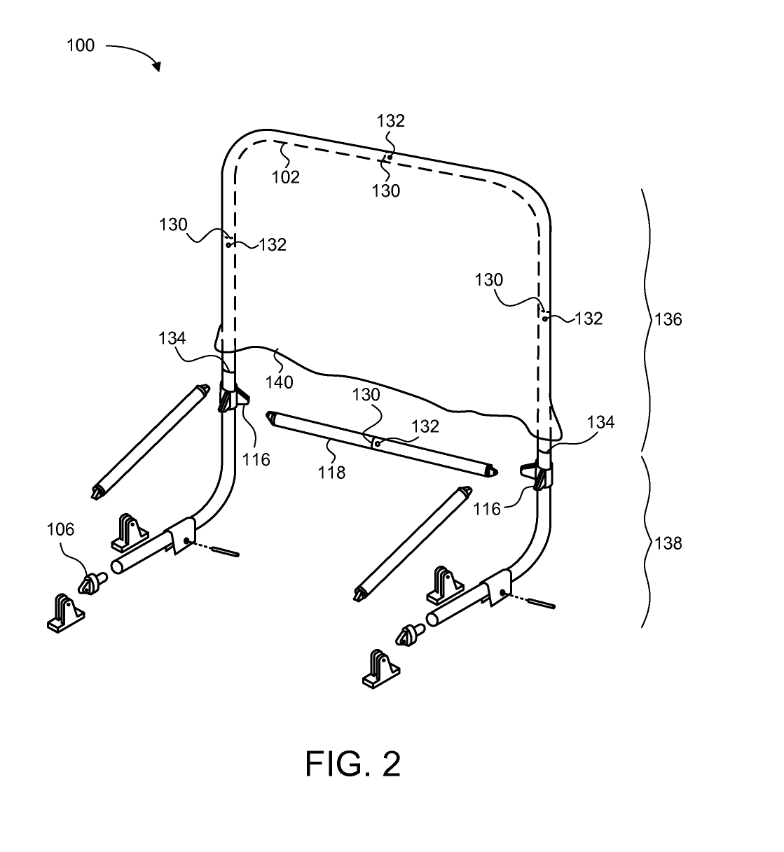

In some embodiments, the bar frame 102 is a single piece. In other embodiments, the bar frame 102 includes multiple sections that may be assembled and disassembled to form the ATV protection system 100. For example, the bar frame 102 may break down for storing or transporting the protection system 100. In some embodiments, the bar frame 102 connects to the pivoting mounts 104 via the pivoting connectors 106. In the illustrated embodiment, the pivoting connectors 106 may be slid over ends of the bar frame 102. In other embodiments, the pivoting connectors 106 may be inserted into ends of the bar frame 102 (as shown in FIG. 2). The pivoting connectors 106 may be attached to the bar frame 102 in other manners. For example, the pivoting connectors 106 may be glued, molded, screwed, pinned, clipped, friction fit, or otherwise affixed to the bar frame 102. In some embodiments, the pivoting connectors 106 and the bar frame 102 may be made from one piece.

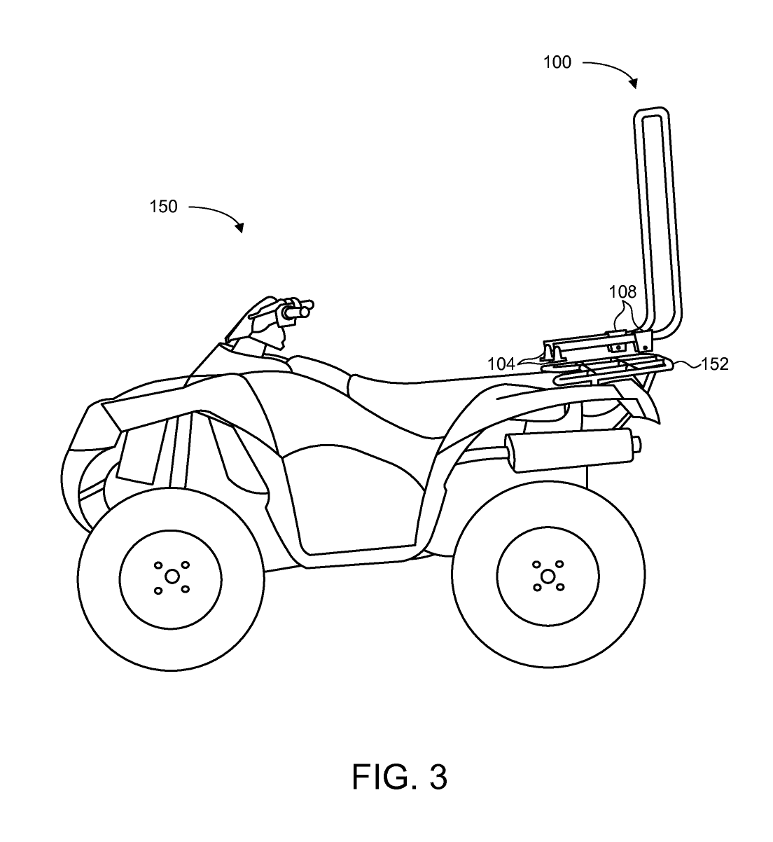

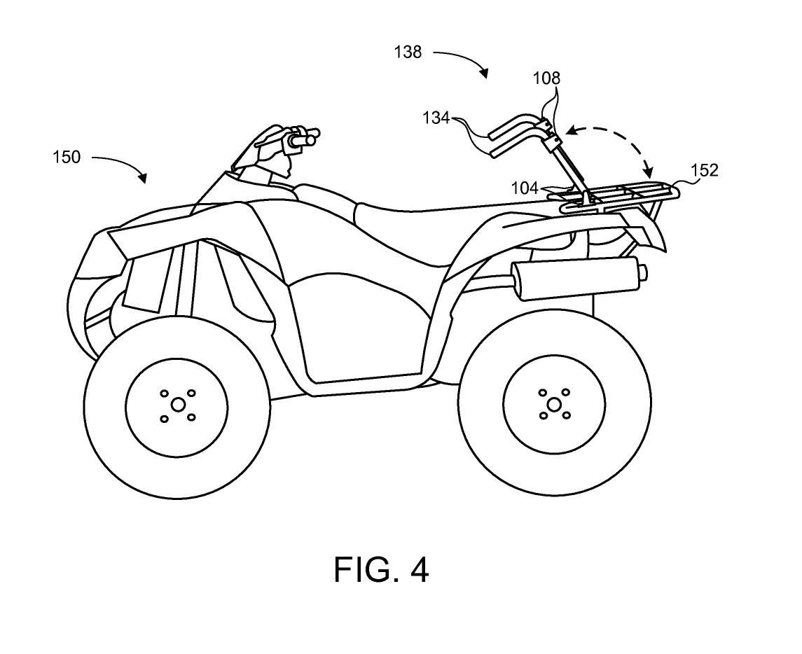

In some embodiments, the pivoting connectors 106 interface with the pivoting mounts 104. The interface between the pivoting connectors 106 and the pivoting mounts 104 may be a pinned or other type of connection which facilitates a pivoting movement of the bar frame 102 relative to the pivoting mounts 104. The pivoting mounts 104 include one or more physical features to facilitate mounting of the system 100 to an ATV or other surface or structure (described in more detail with reference to FIGS. 3 and 4 below). In some embodiments, the pivoting mounts 104 are lubrication-free. In other embodiments, the pivoting mounts 104 may incorporate lubrication or a gasket, seal, or other feature to prevent or reduce particulate introduction into the interface between the pivoting mounts 104 and the pivoting connectors 106.

In some embodiments, the pivoting mounts 104 allow the bar frame 102 to pivot when the releasable latches 108 are disengaged. In some embodiments, the releasable latches 108 are disengaged when a locking pin 110 is removed. Other embodiments may incorporate other manners of engaging or disengaging the releasable latches 108. For example, the releasable latches 108 may include hooks, straps, latches, magnets, ties, clips, hook-and-loop closures, etc. In some embodiments, one or more pieces of the releasable latches 108 may be fixed to a surface. In some embodiments, the releasable latches 108 interface with the one or more fixed pieces to provide the releasable functionality. In other embodiments, the releasable latches 108 are entirely disengaged upon release and do not have separate fixed pieces which remain in place. In some embodiments, the releasable latches 108 remain substantially attached to the bar frame 102 and release from a securing surface. In other embodiments, the releasable latches 108 remain substantially attached to a securing surface and release from the bar frame 102. Other embodiments incorporate other manners of securing the bar frame 102.

In the illustrated embodiment, the protection system or dust guard 100 includes the side supports 112. The side supports 112 provide structural support to the bar frame 102. In some embodiments, the side supports 112 may be at least partially removable from the bar frame 102. In other embodiments, the side supports 112 are fixed to the bar frame 102. The side supports 112 may be configured to reduce torsion or bending or increase the strength of the bar frame 102 during a rollover incident. The side supports 112 may also include vibration damping qualities to reduce the vibration of the bar frame 102 during use. The side supports 112 may be made of similar material to the bar frame 102 or material(s) different from that of the bar frame 102. Fewer or more supports may be included on the bar frame 102 at a variety of angles, lengths, and other orientations.

The side supports 112 include side support connectors 114. The side support connectors 114 may be identical, similar, or unique relative to the pivoting connectors 106. In some embodiments, one or more of the side support connectors 114 are quick release connectors to allow the side supports 112 to be removed or collapsed for storage, transport, or customization. For example, if the user is impeded by the side supports 112, the side support connectors 114 may quickly release to allow the user to use the protection system 100 without one or more of the side supports 112. Also, if the user desires to store the protection system 100, removal of the side supports 112 may better facilitate storage of the protection system 100.

The side supports 112 connect to the support mounts 116. The support mounts 116 may be similar to the pivoting mounts 104. In some embodiments, the support mounts 116 are fixed to the bar frame 102. In other embodiments, the support mounts 116 are moveably coupled to the bar frame 102. For example, the support mounts 116 may slide along the bar frame 102 to make the position of the side supports 114 adjustable relative to the bar frame. The support mounts 116 may be releasable to allow the side support 114 to be removed entirely. In some embodiments, the support mounts 116 may be releasable to collapse the protection system 100 for storage or transport. For example, in one embodiment, the bar frame 102 may be hinged and one or more sets of the support mounts 116 may be hinged to facilitate collapse of the bar frame 102 or releasable to slide along the bar frame 102 to allow the bar frame 102 to collapse. In the illustrated embodiment, some of the support mounts 116 include locations to mount multiple support elements. The support mounts 116 may have multiple support mounting locations or be dedicated to a single support mounting location.

The protection system 100, as illustrated, also includes the adjustable cross bar 118 with the corresponding rear support connectors 120. Embodiments of the adjustable cross bar 118 and the rear support connectors 120 are similar to those described above with relation to the side supports 112 and the side support mounting structures 114. Additionally, the adjustable cross bar 118 may be oriented at any angle. In some embodiments, multiple rear supports 118 are included. The system 100 may include fewer or more support elements and corresponding connectors and mounts in a variety of placements and orientations to prove fewer or more structural support and functionality. In some embodiments, the adjustable cross bar 118 is an adjustable cross bar. In the illustrated embodiment, when the adjustable cross bar 118 is connected to the bar frame 102, the upright portion of the bar frame 102 and the adjustable cross bar form a closed loop. In some embodiments, the closed loop may define the protection area by defining where the area to which a dust protection barrier is attached to the bar frame 102. In some embodiments, the dust protection barrier may be a material fastened or otherwise attached to the bar frame 102 and the adjustable cross bar. The dust protection barrier would cover the opening of the closed loop and form a barrier between a rider of an ATV and the rear end of the ATV.

FIG. 2 depicts an exploded view of another embodiment of a protection system 100 with a dust protection guard 140 and size adjustment structures 130. The illustrated embodiment includes the bar frame 102, the size adjustment structures 130, adjustment mechanisms 132, separation points 134, a protection portion 136, a base 138, and a dust protection guard 140.

The illustrated size adjustment structures 130 allow the physical dimensions of the bar frame 102 to be adjusted. This allows for fitting the bar frame 102 to a range of ATVs with differing geometries and mounting the bar frame 102 in a variety of manners and on a variety of surfaces or locations on the ATV. In the illustrated embodiment, the size adjustment structures 130 allow for the width of the bar frame 102 to be adjusted. This allows for the pivoting mounts 104 and releasable latches 108 to be attached to various size ATVs. Additionally, the adjustment structures 130 may allow for adjustment of the bar frame 102 to fit a dust protection guard 140 or allow for height and width adjustment to suit a user's preference or adjust protection or effect. For example, as the dust protection guard 140 may obstruct the view of a rider it may adjusted in size to better meet the demands of the rider. In some embodiments, the size adjustment structures 130 include adjustment mechanisms 132. The adjustment mechanisms 132 facilitate secure adjustment of the bar frame 102 at the size adjustment structures 130. For example, the adjustment mechanisms 132 may be a spring button clip, a friction lock, a retention screw, or other mechanism that allows for securable adjustment.

The illustrated embodiment also depicts a size adjustment structure 130 with corresponding adjustment mechanism 132 on the adjustable cross bar 118. In some embodiments, the adjustable cross bar 118 may include adjustment means to allow the bar frame 102 to be adjusted without conflicting with or forcing removal of the adjustable cross bar 118 in order to adjust the bar frame 102. In some embodiments, the adjustment of the bar frame 102 and the rear support element 118 are independent. In other embodiments, the adjustment is of the bar frame 102 at the size adjustment structures 130 is dependent.

The separation points 134 allow the bar frame 102 to be separated and may be located at various positions along the bar frame. In some embodiments, the separation points 134 include a necked down portion of the bar frame 102 inserted into another portion of the bar frame 102. The separation points 134 may also include a hinge, threaded inserts, or other flexible or removable attachment. In other embodiments, a locking or securing mechanism (not shown) may be incorporated to secure the bar frame 102 together. In some embodiments, the separation points 134 are located above the support mounts 116. In other embodiments, the separation points 134 are located below the support mounts 116. The separation points 134 may be at other locations on the bar frame 102. In some embodiments, the separation points 134 separate the bar frame 102 into a base frame (the lower portion) and a protection frame (the upper portion). The base frame allows for the system 100 to be connected or otherwise attached to an ATV. The protection frame defines the protection area and can be removed from the base frame allowing for easier transport or storage.

In the illustrated embodiment, the portion and components of the system 100 above the separation points 134 form the protection frame 136 while the portion and components of the system 100 below the separation points 134 form the base frame 138. In some embodiments, the entire protection frame 136 may be removed from the base frame 138 by disengaging the frame at the separation points 134. In other embodiments, the protection frame 136 may be tilted at the separation points 134 to change the orientation of the protection frame 136 relative to the base frame 138. In some embodiments, the rear support or cross bar 118 is part of the protection frame 136. In some embodiments, the rear support or cross bar 118 is part of the base frame 134.

In the illustrated embodiment, the dust protection barrier 140 is placed over the bar frame 102 and extends from the top of the bar frame 102 to the separation points 134. The dust protection barrier 140 occupies at least a portion of a protection area partially defined by the bar frame 102. The dust protection barrier 140 may be shorter or longer to cover more or less of the bar frame 102 and the protection area within the bar frame 102. In some embodiments, the dust protection barrier 140 extends from the top of the bar frame 102 to the adjustable cross bar 118. In the illustrated embodiment, the dust protection barrier 140 is a flexible sleeve placed over the bar frame 102. In other embodiments, the dust protection barrier 140 may attach to the bar frame 102. For example, the dust protection barrier 140 may attach to the bar frame using fasteners such as snaps, hook-and-loop, posts and grommets, loops, straps, magnets, or other systems. The dust protection barrier 140 may be made of a variety of materials, such as vinyl, cloth, fabric, plastic. Some embodiments of the dust protection barrier 140 include one or more flexible materials while others may use one or more rigid materials. For example, the dust protection barrier 140 may be made of a flexible mesh or fabric or a rigid plastic or metal. In some embodiments, the dust protection barrier 140 may include multiple materials. For example, the dust protection barrier 140 may include a combination of flexible and rigid materials.

Some embodiments of the dust protection barrier 140 may include accessories or components to provide additional functionality. For example, the dust protection barrier 140 may include a window to facilitate viewing through the dust protection barrier 140. The dust protection barrier 140 may include cup holders, cushions or pads, armrests, storage, or other functional or decorative elements.

FIG. 3 depicts one embodiment of a protection system 100 as applied to an ATV 150. In the illustrated embodiment, the system 100 is attached to the ATV 150 by coupling the system 100 to the rack 152 of the ATV 150. In some embodiments, the pivoting mounts 104 and the releasable latches 108 mount to the rack 152. In some embodiments, one of the pivoting mounts 104 and the releasable latches 108 attach to the rack 152 while the other structures attach to another component of the ATV 150. In some embodiments, one or both of the pivoting mounts 104 and the releasable latches 108 may be permanently attached to the ATV 150. In another embodiment, both the pivoting mounts 104 and the releasable latches 108 are removably coupled to the ATV 150. In some embodiments, the system 100 may be attached to an intermediate device which couples to the ATV 150. For example, the system 100 may be wider than the rack 152 or other mountable component of the ATV 150 so an intermediate device may be attached to the ATV 150 to facilitate mounting the system 100 to the ATV 150.

While the system 100 is illustrated as a flat panel extending upward from the ATV 150, some embodiments of the system 100 may curve around the seat of the ATV 150 or curve backward or forward relative to the ATV 150. Some embodiments may provide rollover protection, sun protection, dust protection, mud protection, rain/weather protection, wind protection, or other protection to the passenger and/or driver of the ATV 150. In some embodiments, the bar frame 102 may extend beyond the rear of the ATV 150.

FIG. 4 depicts another embodiment of a protection system 100 as applied to an ATV 150. In the illustrated embodiment, the protection frame (136 of FIG. 2) is removed from the separation points 134 leaving the base frame 138. In the illustrated embodiment, the releasable latches 108 are released allowing the base frame 138 to rotate on the pivoting mounts 104 where the pivoting mounts 104 are coupled to the rack 152. In the illustrated embodiment, the base frame 138 may be rotated forward to a storage position. This may allow the rack 152 to be used for cargo space or to store the ATV 150 without the additional height of the protection frame 136 or the base frame 138. In some embodiments, the protection frame 136 may be left on the base frame 138 and the whole system 100 rotated forward.

In some embodiments, the base frame 138 includes the adjustable cross bar 118 (shown with reference to FIG. 1). In this embodiment, the adjustable cross bar 118 may rest on the seat of the ATV 150 when the base frame 138 is rotated forward. Other embodiments may include other structures to facilitate rotation of the base frame 138 into the forward position for storage or transport. For example, the separation points 134 may include bumpers to prevent damage to the ATV 150. Other embodiments may include fewer or more components to achieve less or more functionality.

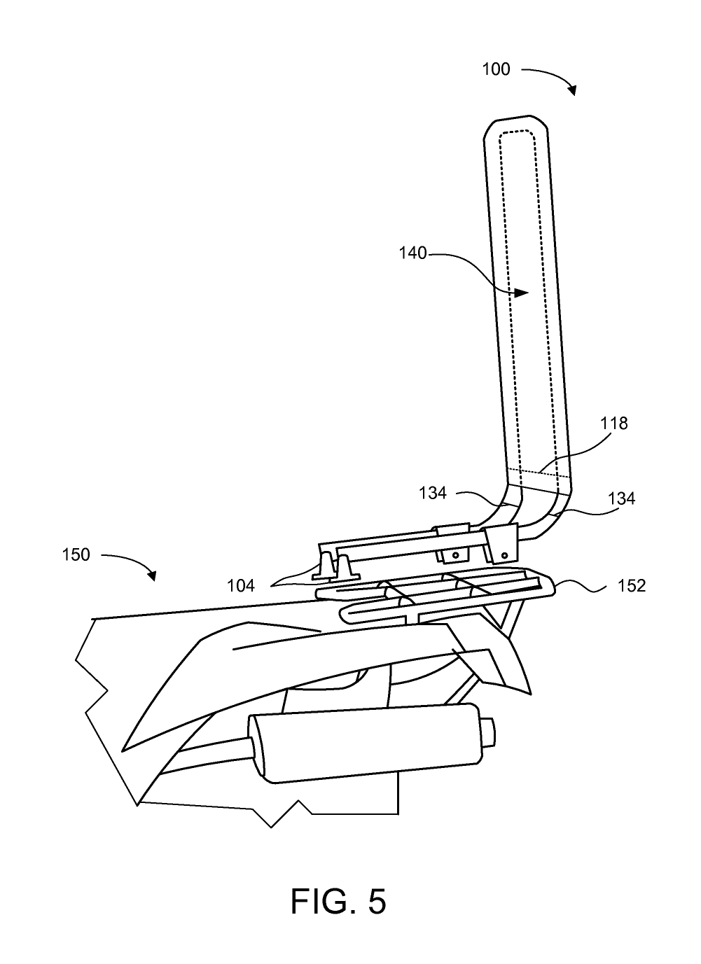

FIG. 5 depicts a close up view of one embodiment of a protection system 100 as applied to a portion of an ATV 150. In the illustrated embodiment, the system 100 is attached to the ATV 150 by coupling the system 100 to the rack 152 of the ATV 150. In some embodiments, the pivoting mounts 104 and the releasable latches 108 mount to the rack 152. In some embodiments, one of the pivoting mounts 104 and the releasable latches 108 attach to the rack 152 while the other structures attach to another component of the ATV 150. In some embodiments, one or both of the pivoting mounts 104 and the releasable latches 108 may be permanently attached to the ATV 150. In some embodiments, both the pivoting mounts 104 and the releasable latches 108 are coupled to the ATV 150. In some embodiments, the system 100 may be attached to an intermediate device which couples to the ATV 150. For example, the system 100 may be wider than the rack 152 or other mountable component of the ATV 150 so an intermediate device may be attached to the ATV 150 to facilitate mounting the system 100 to the ATV 150.

While the system 100 is illustrated as a flat panel extending upward from the ATV 150, some embodiments of the system 100 may curve around the seat of the ATV 150 or curve backward or forward relative to the ATV 150. Some embodiments may provide rollover protection, sun protection, dust protection, mud protection, rain/weather protection, wind protection, or other protection to the passenger and/or driver of the ATV 150. In some embodiments, the bar frame 102 may extend beyond the rear of the ATV 150. Some embodiments includes a dust protection barrier 140. In the illustrated embodiment, the dust protection barrier extends from the top of the bar frame 102 all the way to the cross bar 118. In some embodiments, the dust protection barrier 140 may be a sleeve that slides over the bar frame 102 covering a protection area within the bar frame 102. In the illustrated embodiments extends away from the ATF between a seat on the ATV and a rear end of the ATV.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An ATV dust guard comprising:
a bar frame to define a protection area connected to an ATV;
a dust protection barrier attached to the bar frame, the dust protection barrier forming a barrier extending away from the ATV between a seat on the ATV and a rear end of the ATV;
a pivoting mount coupled to the bar frame, the pivoting mount securing the bar frame to a surface of the ATV;
a releasable latch attached to the ATV, the releasable latch preventing the bar frame from pivoting at the pivoting mount.

2. The ATV dust guard of claim 1,
the bar frame comprising a base frame,
wherein the base frame comprises the pivoting mount; and
wherein the releasable latch latches the bar frame to the ATV preventing the bar frame from pivoting at the pivoting mount.

3. The ATV dust guard of claim 1,
the bar frame comprising a portion forming a closed loop,
the closed loop defining the protection area; and
wherein the dust protection barrier comprises a flexible material and covers the protection area.

4. The ATV dust guard of claim 1,
the bar frame comprising a portion forming a closed loop,
the closed loop defining the protection area; and
wherein the dust protection barrier comprises a rigid material clipped to the bar frame at the closed loop and covers the protection area.

5. The ATV dust guard of claim 1,
the bar frame extending perpendicular from a top of the ATV, wherein the bar frame is connected to the ATV only at the pivoting mount and at the releasable latch.

6. The ATV dust guard of claim 1,
further comprising a second pivoting mount,
wherein the pivoting mount and the second pivoting mount are mounted to the ATV on opposite sides of the ATV.

7. The ATV dust guard of claim 1,
the bar frame extending beyond the rear end of the ATV.

8. The ATV dust guard of claim 1,
the bar frame comprising a base frame,
wherein the base frame comprises the pivoting mount;
wherein the releasable latch latches the bar frame to the ATV preventing the bar frame from pivoting at the pivoting mount;
the bar frame comprising a portion forming a closed loop,
the closed loop defining the protection area;
wherein the dust protection barrier covers the protection area; and
the bar frame extending beyond the rear end of the ATV.

9. The ATV dust guard of claim 1,
the bar frame comprising a portion forming a closed loop,
the closed loop defining the protection area; and
wherein the closed loop comprises an adjustable cross bar, wherein the adjustable cross bar adjusts the size of the closed loop and the protection area.

10. An ATV dust guard apparatus comprising:
a bar frame, the bar frame comprising a base frame and a protection frame, the base frame connected to an ATV;
a pivoting mount coupled to the base frame, the pivoting mount securing the base frame to the ATV;
a releasable latch attached to the ATV, wherein the releasable latch latches to the base frame, preventing the base frame from pivoting at the pivoting mount; and
a dust protection barrier attached to the protection frame, the dust protection barrier forming a barrier extending away from the ATV.

11. The ATV dust guard apparatus of claim 10,
the protection frame comprising a portion forming a closed loop,
the closed loop defining a protection area; and
wherein the dust protection barrier comprises a flexible material and covers the protection area.

12. The ATV dust guard apparatus of claim 10,
the protection frame comprising a portion forming a closed loop,
the closed loop defining a protection area; and
wherein the dust protection barrier comprises a rigid material attached to the protection frame at the closed loop and covers the protection area.

13. The ATV dust guard apparatus of claim 10,
the protection frame extending from the base frame in a direction perpendicular from a top of the ATV, wherein the base frame is connected to the ATV only at the pivoting mount and at the releasable latch.

14. The ATV dust guard of apparatus claim 10,
further comprising a second pivoting mount,
wherein the pivoting mount and the second pivoting mount are mounted to the ATV on opposite sides of the ATV.

15. The ATV dust guard of apparatus claim 10,
the bar frame extending beyond a rear end of the ATV.

16. The ATV dust guard of apparatus claim 10,
the protection frame comprising a portion forming a closed loop,
the closed loop defining a protection area; and
wherein the protection frame comprises an adjustable cross bar, wherein the adjustable cross bar adjusts the size of the closed loop and the protection area.

17. An ATV protection system comprising:
a bar frame to define a protection area;
a dust protection guard applied to the bar frame, the dust protection guard forming a barrier to substantially prevent dust from passing through the protection area;
a pivoting mount coupled to the bar frame, the pivoting mount configured to secure the bar frame to a surface of an ATV and allow the bar frame to pivot at the pivoting mount; and
a releasable latch configured to prevent the bar frame from pivoting at the pivoting mount when secured and to allow the bar frame to pivot at the pivoting mount when released.

18. The system of claim 17,
wherein the bar frame comprises a base frame and a protection frame;
wherein the protection frame connects to the base frame;
wherein the protection frame comprises the dust protection guard,
the protection frame removable from the base frame, wherein the base comprises the pivoting mount, the releasable latch, and a portion of the bar frame corresponding to the pivoting mount and the releasable latch.

19. The system of claim 17, wherein the releasable mounting structure comprises a removable pin.

20. The system of claim 17, wherein the bar frame comprises a size adjustment structure to adjust a dimension of the bar frame.
